(19) United States
(12) Patent Application Publication
(10) Pub. No.: US 2022/0172617 A1
(43) Pub. Date: Jun. 2, 2022

(54) INFORMATION MANAGEMENT APPARATUS AND INFORMATION MANAGEMENT SYSTEM

(71) Applicant: HONDA MOTOR CO., LTD., Tokyo (JP)

(72) Inventors: Naoki OKIMOTO, Wako-shi (JP); Toraki IWAMARU, Wako-shi (JP); Keiichi MIZUMURA, Wako-shi (JP); Sho TAJIMA, Wako-shi (JP)

(21) Appl. No.: 17/536,592

(22) Filed: Nov. 29, 2021

(30) Foreign Application Priority Data
Dec. 2, 2020 (JP) 2020-200463

(51) Int. Cl. G08G 1/0967; B60Q 1/44; B60W 50/14

(52) U.S. Cl. CPC G08G 1/096733; G08G 1/096791; B60W 2556/45; B60W 50/14; B60W 2050/146; B60Q 1/44

(57) ABSTRACT

An information management apparatus, comprising an acquisition unit configured to acquire vehicle location information indicating a location of a certain vehicle and vehicle state information indicating a state of the vehicle, a selection unit configured to select another vehicle corresponding to the vehicle state information from among other vehicles in surroundings of the vehicle that are identified based on the vehicle location information, and a notification unit configured to notify the another vehicle that has been selected in accordance with the vehicle state information.

### CROSS-REFERENCE TO RELATED APPLICATION(S)

This application claims priority to and the benefit of Japanese Patent Application No. 2020-200463 filed on Dec. 2, 2020, the entire disclosure of which is incorporated herein by reference.

### BACKGROUND OF THE INVENTION

### Field of the Invention

The present invention relates to an information management apparatus that manages information of vehicles.

### Description of the Related Art

Japanese Patent Laid Open No. 2016-020189 discloses that when a failure of a lighting device is detected in a certain vehicle, the surroundings are informed of the situation.

### SUMMARY OF THE INVENTION

Such information can be useful for some drivers of the other vehicles in the surroundings to achieve an appropriate driving operation, but is unnecessary for the other drivers of the other vehicles in some cases, and may rather lead to disturbing of road traffic.

An exemplary object of the present invention is to manage information about vehicles without disturbing road traffic.

One aspect of the present invention relates to an information management apparatus, and the information management apparatus includes: an acquisition means for acquiring vehicle location information indicating a location of a certain vehicle and vehicle state information indicating a state of the vehicle; a selection means for selecting another vehicle corresponding to the vehicle state information from among other vehicles in surroundings of the vehicle that are identified based on the vehicle location information; and a notification means for notifying the another vehicle that has been selected in accordance with the vehicle state information.

### BRIEF DESCRIPTION OF THE DRAWINGS

FIG. 1 is a diagram illustrating a configuration example of an information management system according to an embodiment;

FIG. 2 is a flowchart illustrating a mode in management of information;

FIG. 3A is a schematic top view illustrating an example of a case where a lighting device is substantially unworkable;

FIG. 3B is a schematic top view illustrating an example of a case where a lighting device is substantially unworkable;

FIG. 3C is a schematic top view illustrating an example of a case where a lighting device is substantially unworkable;

FIG. 4A is a diagram illustrating display contents of a display;

FIG. 4B is a diagram illustrating display contents of a display; and

FIG. 4C is a diagram illustrating display contents of a display.

### DESCRIPTION OF THE EMBODIMENTS

Hereinafter, an embodiment will be described in detail with reference to the accompanying drawings. Note that the following embodiment does not limit the invention according to the claims, and not all combinations of features described in the embodiment are essential to the invention. Two or more of a plurality of the features described in the embodiment may be optionally combined together. In addition, the same or similar constituent elements are denoted by the same reference numerals, and overlapping descriptions will be omitted.

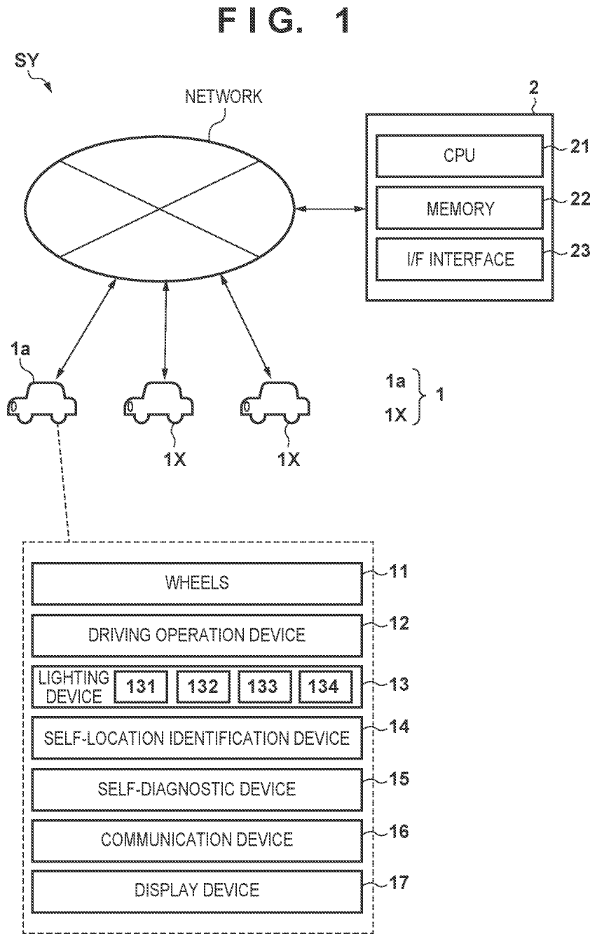

FIG. 1 illustrates a configuration example of an information management system SY according to an embodiment. The information management system SY includes one or more vehicles 1, and an information management apparatus 2. It is assumed that each vehicle 1 is configured to be capable of wirelessly communicating with the information management apparatus 2. In the figure, by focusing on a certain vehicle 1, such a certain vehicle 1 is indicated as a host vehicle 1a, and another vehicle is indicated as another vehicle 1X (in the following description, the vehicle is simply referred to as a vehicle 1, when not being distinguished in particular).

The vehicle 1 includes wheels 11, a driving operation device 12, a lighting device 13, a self-location identification device 14, a self-diagnostic device 15, a communication device 16, and a display device 17. In the present embodiment, the vehicle 1 is a four-wheeled vehicle including a pair of left and right front wheels and a pair of left and right rear wheels as the wheels 11, but the number of the wheels 11 is not limited to the present example. For example, as another embodiment, the vehicle 1 may be a two-wheeled vehicle, a three-wheeled vehicle, or the like. Alternatively, a crawler type vehicle provided with the wheels 11 as its part may be adopted.

The driving operation device 12 includes an operator for performing a driving operation of the vehicle 1, specifically, an acceleration operator, a braking operator, a steering operator, a lighting operator, and the like. A typical example of the acceleration operator is an accelerator pedal. A typical example of the braking operator is a brake pedal. A typical example of the steering operator is a steering wheel. In addition, a headlight switch/blinker lever can be mentioned as a typical example of the lighting operator. Note that methods of operating the operators are not limited to those in the present example, and other configurations such as a lever type, a switch type, or the like may be adopted for the operators.

The lighting device 13 includes a headlight 131, a tail light 132, a direction indicator (blinker) 133, and stop lamp 134. A pair of left and right direction indicators 133 are generally provided in each of front parts and rear parts in a vehicle body (provided at four positions in total). For example, a driver operates the lighting operator of the driving operation device 12, so the headlight 131, and the tail light 132, and the direction indicator 133 are driven. In addition, for example, the driver operates the braking operator of the driving operation device 12, so the stop lamp 134 is driven.

The self-location identification device 14 is configured to be capable of identifying the location of the vehicle 1 on map data (hereinafter, simply referred to as a “self-location” in some cases), and a global positioning system (GPS) sensor can be generally used. As another embodiment, the self-location may be identified by road-to-vehicle communication or vehicle-to-vehicle communication. The self-location identification device 14 may be referred to as a location identification device or simply as an identification device.

The self-diagnostic device 15 is configured to be capable of diagnosing the state of the vehicle 1, and mainly diagnoses whether each element included in the vehicle 1 is capable of appropriately working. This diagnosis may be conducted by a known method, and is achievable by, for example, monitoring an output voltage from a corresponding control circuit or drive circuit. Alternatively, the diagnosis can also be achieved by transmitting a predetermined test pattern to an element that is a diagnosis target and receiving a response from the diagnosis target. In the present embodiment, the self-diagnostic device 15 diagnoses whether the lighting device 13 (individually, the headlight 131, the tail light 132, the direction indicator 133, and the stop lamp 134) is capable of working appropriately. The self-diagnostic device 15 may be referred to as a vehicle state diagnostic device or simply a diagnostic device.

The communication device 16 is a transmission and reception device for wirelessly communicating with the information management apparatus 2. The communication device 16 in the host vehicle 1a transmits, to the information management apparatus 2, an identification result by the self-location identification device 14 and a diagnosis result by the self-diagnostic device 15. In addition, the communication device 16 in the host vehicle 1a receives a notification to be described later from the information management apparatus 2.

Although details will be described later, the display device 17 displays information for appropriately performing a driving operation, and it is sufficient if a known device such as a liquid crystal display is used for the display device 17.

The information management apparatus 2 includes a central processing unit (CPU) 21, a memory 22, and an external communication interface 23. With such a configuration, the information management apparatus 2 is capable of performing a predetermined arithmetic process, and the function of the information management apparatus 2 to be described later is achievable by the CPU 21 executing a predetermined program using data or information expanded on the memory 22.

Note that, instead of the above configuration, a known semiconductor device such as an application specific integrated circuit (ASIC) may be used for the information management apparatus 2. That is, the function of the information management apparatus 2 is achievable by any of software and hardware.

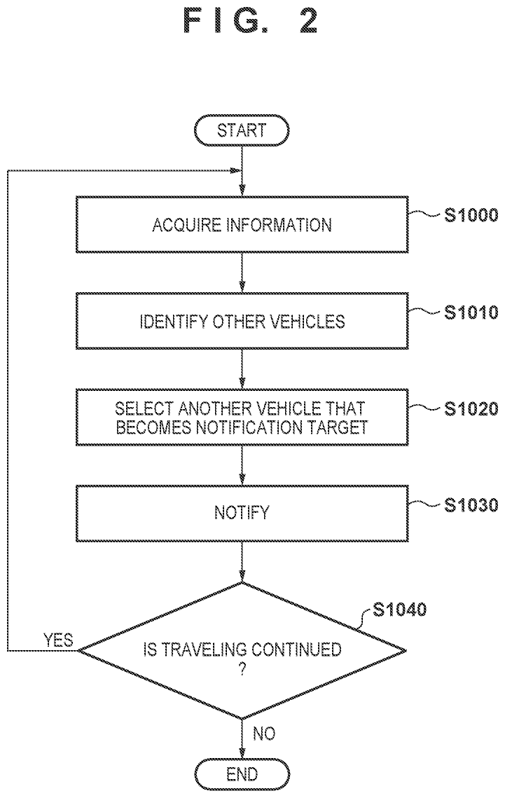

FIG. 2 is a flowchart illustrating a mode in management of information about the vehicle 1. The present flowchart is mainly carried out by the information management apparatus 2, and its outline is to give a corresponding notification to another vehicle 1 to be useful for the driving operation, based on vehicle location information and vehicle state information about each of the vehicles 1.

In S1000, from the target vehicle 1 (here, the vehicle 1a is assumed), vehicle location information i1 indicating the location of the vehicle 1a and vehicle state information i2 indicating the state of the vehicle 1 are acquired. The vehicle location information i1 indicates an identification result of the self-location identification device 14, that is, the location of the vehicle 1a on the map data. In the present step, the CPU 21 together with the memory 22 is supposed to function as an acquisition unit that acquires the vehicle location information i1 and the vehicle state information i2.

In addition, the vehicle state information i2 includes information i21 indicating a working state of the lighting device 13 provided in the vehicle 1a. The information i21 indicates a diagnosis result of the self-diagnostic device 15, and in the present embodiment, indicates whether each of the headlight 131, the tail light 132, the direction indicator 133, and the stop lamp 134 is appropriately workable. Whether each of the headlight 131, the tail light 132, the direction indicator 133, and the stop lamp 134 is appropriately workable is determined, based on whether its light amount satisfies a standard.

For example, in a case where the light amount of the headlight 131 does not satisfy the standard, the information i21 indicates the fact (or indicates that the headlight 131 is substantially unworkable). Alternatively or incidentally, in a case where the light amount of the tail light 132 does not satisfy the standard, the information i21 indicates the fact (or indicates that the tail light 132 is substantially unworkable). Alternatively or incidentally, in a case where the light amount of the direction indicator 133 does not satisfy the standard, the information i21 indicates the fact (or indicates that the direction indicator 133 is substantially unworkable). In addition, alternatively or incidentally, in a case where the light amount of the stop lamp 134 does not satisfy the standard, the information i21 indicates the fact (or indicates that the stop lamp 134 is substantially unworkable).

As described above, the pair of left and right direction indicators 133 are generally provided at each of the front parts and the rear parts in the vehicle body. Therefore, in a case where the light amount of any of them does not satisfy the standard, the information i21 indicates which one of the direction indicators 133 is unworkable. Note that a pair of left and right headlights 131 are provided at front parts of the vehicle body, and a pair of left and right tail lights 132 and a pair of left and right stop lamps 134 are provided at rear parts of the vehicle body. Therefore, the above description also applies to the headlights 131, the tail lights 132, and the stop lamps 134.

Incidentally, the vehicle state information i2 further includes information i22 and i23. The information i22 indicates a speed of the vehicle 1a, and is acquirable based on a detection result of a vehicle speed sensor that can be provided in the vehicle 1a. The information i23 indicates an acceleration of the vehicle 1a, and is acquirable based on a detection result of an acceleration sensor that can be provided in the vehicle 1a.

In S1010, other vehicles 1X in the surroundings of the vehicle 1a are identified, based on the vehicle location information i1 acquired in S1000. It is assumed that the surroundings of the vehicle 1a fall within a predetermined range from the vehicle 1a. However, the range may be variable based on the information i22 and i23. For example, in a case where the speed and/or the acceleration of the vehicle 1a is relatively large, the above range for identification may be made relatively broad. In the present step, the CPU 21 together with the memory 22 is supposed to function as an identification unit that identifies the other vehicles 1X in the surroundings of the vehicle 1a.

In S1020, a vehicle corresponding to the vehicle state information i2 is selected from the other vehicles 1X identified in S1010. In the present step, the CPU 21 together with the memory 22 is supposed to function as a selector that selects another vehicle 1X that becomes a notification target (S1030) to be described later.

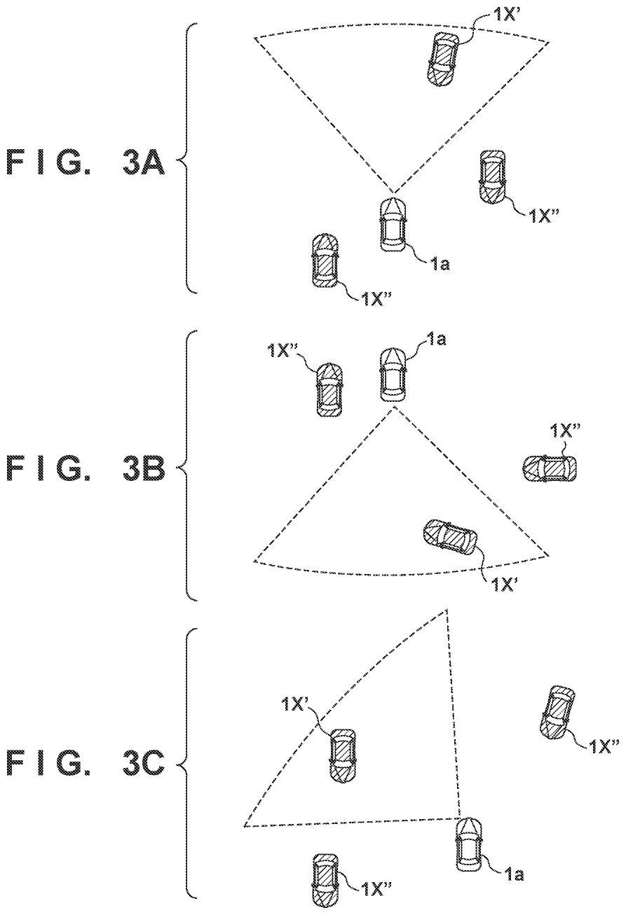

Here, FIG. 3A, FIG. 3B, and FIG. 3C are schematic top views illustrating some examples in a case where the lighting device 13 is substantially unworkable. Broken lines in FIG. 3A indicate that the light amount of the headlight 131 does not satisfy the standard. It can be said that the unworkable headlight 131 in the vehicle 1a can hinder the driver of another vehicle 1X′ (illustrated as “another vehicle 1X′” in order to distinguish from the above-described other vehicles 1X, and the other vehicles are illustrated as “other vehicles 1X″”) traveling ahead of the vehicle 1a from performing an appropriate driving operation. Note that the term traveling used herein also includes simply being located, such as a temporary stop.

Broken lines in FIG. 3B indicate that the light amount of the tail light 132 and/or the stop lamp 134 does not satisfy the standard. It can be said that the unworkable state of the tail light 132 and/or the stop lamp 134 in the vehicle 1a can hinder the driver of another vehicle 1X′ traveling behind the vehicle 1a from performing an appropriate driving operation.

Broken lines in FIG. 3C indicate that the light amount of the direction indicator 133 on the left front side does not satisfy the standard. It can be said that the unworkable state of the direction indicator 133 on the front left side of the vehicle 1a can hinder the driver of another vehicle 1X′ traveling on the front left side of the vehicle 1a from performing an appropriate driving operation.

Note that ranges or regions indicated by the broken lines in FIG. 3A to FIG. 3C vary depending on the vehicle type, may also vary depending on the season and the date and time, and are not limited to those illustrated here.

Referring to FIG. 2 again, in a case where the information i21 indicates that the light amount of the headlight 131 does not satisfy the standard in S1020, another vehicle (another vehicle 1X′ in FIG. 3A) traveling ahead of the vehicle 1a is selected from the other vehicles 1X in the surroundings of the vehicle 1a. Note that as described above, the pair of left and right headlights 131 are provided at the front parts of the vehicle body. Therefore, the above selection range may be changed by one of the pair of left and right headlights 131, the light amount of which does not satisfy the standard.

In addition, in a case where the information i21 indicates that the light amount of the tail light 132 and/or the stop lamp 134 does not satisfy the standard, another vehicle 1X traveling behind the vehicle 1a (another vehicle 1X′ in FIG. 3B) is selected from the other vehicles 1X in the surroundings of the vehicle 1a. Note that as described above, a pair of left and right tail lights 132 and stop lamps 134 are respectively provided at front parts of the vehicle body. Therefore, the range of the selection may be changed by any of the pair of left and right headlights 131, the light amount of which does not satisfy the standard.

Similarly, in a case where the information i21 indicates that the light amount of any of the direction indicators 133 does not satisfy the standard, the corresponding one of the other vehicles 1X in the surroundings is selected. For example:

in a case where the information i21 indicates that the light amount of the direction indicator 133 on the left front side does not satisfy the standard, a vehicle (another vehicle 1X′ in FIG. 3C) traveling on the left front side of the vehicle 1a is selected from among the other vehicles 1X in the surroundings;

in a case where the information i21 indicates that the light amount of the direction indicator 133 on the left rear side does not satisfy the standard, a vehicle traveling on the left rear side of the vehicle 1a is selected from among the other vehicles 1X in the surroundings;

in a case where the information i21 indicates that the light amount of the direction indicator 133 on the right front side does not satisfy the standard, a vehicle traveling on the right front side of the vehicle 1a is selected from among the other vehicles 1X in the surroundings; and

in a case where the information i21 indicates that the light amount of the direction indicator 133 on the right rear side does not satisfy the standard, a vehicle traveling on the right rear side of the vehicle 1a is selected from among the other vehicles 1X in the surroundings.

In S1030, a notification corresponding to the vehicle state information i2 is given to another vehicle 1X selected in S1020. It is sufficient if this notification enables recognition that the driver of another vehicle 1X should pay attention to the behavior of which one of the vehicles 1. Details will be described later, but it is sufficient to be illustrated on the display device 17 of another vehicle 1X. In the present step, the CPU 21 together with the memory 22 is supposed to function as a notification unit that notifies another vehicle 1X that is a target.

In S1040, it is determined whether the vehicle 1a continues traveling. In a case where the traveling is continued, the process returns to S1000, and in the other cases, the process ends the present flowchart.

The above flowchart focuses on the vehicle 1a here, but is performed for each of the other vehicles 1X in a similar manner.

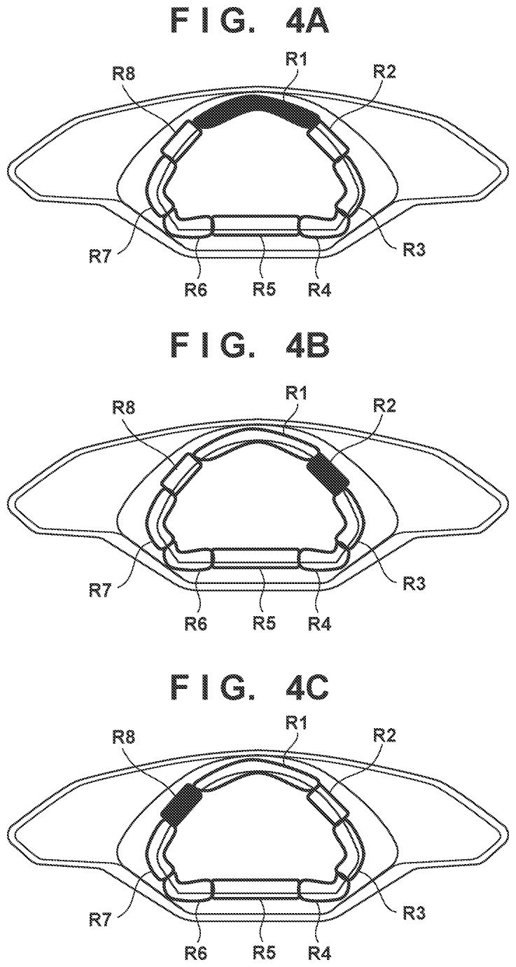

FIG. 4A, FIG. 4B, and FIG. 4C respectively illustrate display contents displayed on the display device 17 of another vehicle 1X, based on the notification of S1030 that has been transmitted to another vehicle 1X illustrated in FIG. 3A, FIG. 3B, and FIG. 3C.

The display device 17 includes a plurality of display regions R1 to R8 for getting the driver's attention, and is installed on an instrument panel in the present embodiment. The region R1 corresponds to a front region, the region R2 corresponds to a front right lateral region, the region R3 corresponds to a right lateral region, the region R4 corresponds to a rear right lateral region, the region R5 corresponds to a rear region, the region R6 corresponds to a rear left lateral region, the region R7 corresponds to a left lateral region, and the region R8 corresponds to a front left lateral region. The regions R1 to R8 can be independently in a turned-on state, a blinking state, or a turned-off state, and the driver visually recognizes this to be able to relatively easily grasp in which direction the vehicle 1a, the lighting device 13 of which is substantially unworkable, is located.

In the example of FIG. 3A, the vehicle 1a is located on the front side of another vehicle 1X′. Therefore, as illustrated in FIG. 4A corresponding to the example of FIG. 3A, the region R1 is in the turned-on state on the display device 17 of another vehicle 1X′.

In the example of FIG. 3B, the vehicle 1a is located on the front right lateral side of another vehicle 1X′. Therefore, as illustrated in FIG. 4B corresponding to the example of FIG. 3B, the region R2 is in the turned-on state on the display device 17 of another vehicle 1X′.

In the example of FIG. 3C, the vehicle 1a is located on the front left lateral side of another vehicle 1X′. Therefore, as illustrated in FIG. 4C corresponding to the example of FIG. 3C, the region R8 is in the turned-on state on the display device 17 of another vehicle 1X′.

In addition, the luminance (or color intensity) when the regions R1 to R8 are in the turned-on state may be variable based on the information i22 and i23. For example, the regions R1 to R8 may be in the turned-on state at relatively high luminance (or at a relatively dense state), in a case where the speed and/or the acceleration of the vehicle 1a is relatively large.

For the same purpose, the blinking interval when the regions R1 to R8 are in the blinking state may be variable based on the information i22 and i23. For example, in the regions R1 to R8, the blinking interval may be shortened when the speed and/or the acceleration of the vehicle 1a is relatively high.

According to such a display mode, the driver of another vehicle 1X′ visually recognizes the regions R1 to R8 to be able to relatively easily grasp in which direction the vehicle 1a, the lighting device 13 of which is substantially unworkable, is located with respect to another vehicle 1X′. In order to make this appropriately achievable, the notification in S1030 can include information indicating a relative location of the vehicle 1a with respect to another vehicle 1X′. Alternatively, the notification in S1030 may include the vehicle location information i1 itself of the vehicle 1a, and in this case, the relative location of the vehicle 1a with respect to another vehicle 1X′ can be calculated by an arithmetic device included in another vehicle 1X′.

As described above, the information management apparatus 2 gives a corresponding notification to another vehicle 1X′ to be useful for the driving operation, based on the vehicle location information and the vehicle state information about the vehicle 1a. This is conducted in the plurality of vehicles 1 capable of communicating with the information management apparatus 2, and thus the road traffic becomes appropriately manageable. According to the present embodiment, the notification in S1030 is not given to unrelated other vehicles 1X″. Therefore, unnecessary information complication is prevented, and thus the road traffic becomes appropriately manageable. The information management apparatus 2 may also be expressed as a traffic management device, and the information management system SY may also be expressed as a traffic management system for the same purpose.

In addition, in the present embodiment, the mode in which pieces of the information i1 and i2 are supplied from each vehicle 1 to the information management apparatus 2 has been given as an example. However, the pieces of the information i1 and i2 don't have to be necessarily supplied from the vehicle 1. For example, the individual vehicle 1 may be monitored by imaging cameras installed in a city area, a building, or the like, and the pieces of information i1 and i2 may be supplied to the information management apparatus 2 by analyses based on the monitoring results.

In the above description, for ease of understanding, each element has been given a name related to its functional aspect. Meanwhile, each element is not limited to one having, as a main function, the function described in the embodiment, and may be one having the function as an auxiliary function. Therefore, each element is not strictly limited to wording, and the wording can be replaced with similar wording. For the same purpose, the term “apparatus” may be replaced with “unit”, “component”, “piece”, “member”, “structure”, “assembly”, or the like, or may be omitted.

The embodiments can be summarized as follows:

a first aspect relates to an information management apparatus (for example, 2), and the information management apparatus includes

an acquisition means (for example, S1000) for acquiring vehicle location information (for example, i1) indicating a location of a certain vehicle (for example, 1a) and vehicle state information (for example, i2) indicating a state of the vehicle,

a selection means (for example, S1010, S1020) for selecting another vehicle (for example, 1X′) corresponding to the vehicle state information from among other vehicles (for example, 1X) in surroundings of the vehicle that are identified based on the vehicle location information, and

a notification means (for example, S1030) for notifying the another vehicle that has been selected in accordance with the vehicle state information. Accordingly, the information about the vehicles becomes manageable without disturbing the road traffic.

In a second aspect,

the vehicle state information includes first information (for example, i21) indicating a working state of a lighting device (for example, 13) included in the vehicle.

Accordingly, the above first aspect is appropriately achievable.

In a third aspect,

the lighting device includes a headlight (for example, 131), and

in a case where the first information indicates that a light amount of the headlight does not satisfy a standard, the selection means selects another vehicle traveling ahead of the vehicle, and the notification means gives a notification to the another vehicle that has been selected.

The range in which the headlight influences the road traffic is ahead of the vehicle, and thus information is shared with the other vehicles in the range. Therefore, the above first aspect is appropriately achievable.

In a fourth aspect,

the lighting device includes a tail light (for example, 132), and

in a case where the first information indicates that a light amount of the tail light does not satisfy a standard, the selection means selects another vehicle traveling behind the vehicle, and the notification means gives a notification to the another vehicle that has been selected.

The range in which the tail light influences the road traffic is behind the vehicle, and thus information is shared with the other vehicles in the range. Therefore, the above first aspect is appropriately achievable.

In a fifth aspect,

the lighting device includes a direction indicator (for example, 133), and

in a case where the first information indicates that a light amount of the direction indicator does not satisfy a standard, the selection means selects another vehicle traveling on a lateral side of the vehicle, and the notification means gives a notification to the another vehicle that has been selected.

The range in which the direction indicator influences the road traffic is a lateral side of the vehicle, and thus information is shared with the other vehicles in the range. Therefore, the above first aspect is appropriately achievable.

In a sixth aspect,

the lighting device includes a stop lamp (for example, 134), and

in a case where the first information indicates that a light amount of the stop lamp does not satisfy a standard, the selection means selects another vehicle traveling behind the vehicle, and the notification means gives a notification to the another vehicle that has been selected.

The range in which the stop lamp influences the road traffic is behind the vehicle, and thus information is shared with the other vehicles in the range. Therefore, the above first aspect is appropriately achievable.

In a seventh aspect,

the vehicle state information further includes second information (for example, i22) indicating a speed of the vehicle.

Accordingly, the driver of another vehicle is able to grasp the influence from the above certain vehicle in more detail. In addition, the range of sharing information may be changed, based on the speed of the above certain vehicle.

In an eighth aspect,

the vehicle state information further includes third information (for example, i23) indicating an acceleration of the vehicle.

Accordingly, the driver of another vehicle is able to grasp the influence from the above certain vehicle in more detail. In addition, the range of sharing information may be changed, based on the acceleration of the above certain vehicle.

A ninth aspect relates to an information management system (for example, SY), and the information management system includes

the above-described information management apparatus (for example, 2), and

one or more vehicles (for example, 1) capable of wirelessly communicating with the information management apparatus. Accordingly, the road traffic becomes appropriately manageable.

In a tenth aspect,

the another vehicle that has been selected includes a display device (for example, 17) that displays a content of the notification given by the notification means.

Accordingly, it is possible to make the driver of another vehicle visually recognize the notification given by the notification means.

The invention is not limited to the foregoing embodiments, and various variations/changes are possible within the spirit of the invention.

What is claimed is:

1. An information management apparatus comprising:
an acquisition unit configured to acquire vehicle location information indicating a location of a certain vehicle and vehicle state information indicating a state of the vehicle;
a selection unit configured to select another vehicle corresponding to the vehicle state information from among other vehicles in surroundings of the vehicle that are identified based on the vehicle location information; and
a notification unit configured to notify the another vehicle that has been selected in accordance with the vehicle state information.

2. The information management apparatus according to claim 1, wherein
the vehicle state information includes first information indicating a working state of a lighting device included in the vehicle.

3. The information management apparatus according to claim 2, wherein
the lighting device includes a headlight, and
in a case where the first information indicates that a light amount of the headlight does not satisfy a standard, the selection unit selects another vehicle traveling ahead of the vehicle, and the notification unit gives a notification to the another vehicle that has been selected.

4. The information management apparatus according to claim 2, wherein
the lighting device includes a tail light, and
in a case where the first information indicates that a light amount of the tail light does not satisfy a standard, the selection unit selects another vehicle traveling behind the vehicle, and the notification unit gives a notification to the another vehicle that has been selected.

5. The information management apparatus according to claim 2, wherein
the lighting device includes a direction indicator, and
in a case where the first information indicates that a light amount of the direction indicator does not satisfy a standard, the selection unit selects another vehicle traveling on a lateral side of the vehicle, and the notification unit gives a notification to the another vehicle that has been selected.

6. The information management apparatus according to claim 2, wherein
the lighting device includes a stop lamp, and
in a case where the first information indicates that a light amount of the stop lamp does not satisfy a standard, the selection unit selects another vehicle traveling behind the vehicle, and the notification unit gives a notification to the another vehicle that has been selected.

7. The information management apparatus according to claim 2, wherein
the vehicle state information further includes second information indicating a speed of the vehicle.

8. The information management apparatus according to claim 2, wherein
the vehicle state information further includes third information indicating an acceleration of the vehicle.

9. An information management system comprising:
the information management apparatus according to claim 1; and
one or more vehicles capable of wirelessly communicating with the information management apparatus.

10. The information management system according to claim 9, wherein
the another vehicle that has been selected includes a display device that displays a content of the notification given by the notification unit.
